(19) United States
(12) Patent Application Publication
(10) Pub. No.: US 2014/0274821 A1
(43) Pub. Date: Sep. 18, 2014

(54) REINFORCED HYDRAULIC FRACTURING FLUID PROPPANT AND METHOD

(71) Applicant: Stabilizer Solutions, Inc., Phoenix, AZ (US)

(72) Inventors: W. Wayne Freed, Phoenix, AZ (US); Jonathan W. Hubbs, Phoenix, AZ (US)

(73) Assignee: Stabilizer Solutions, Inc., Phoenix, AZ (US)

(21) Appl. No.: 14/210,241

(22) Filed: Mar. 13, 2014

Related U.S. Application Data
(60) Provisional application No. 61/780,633, filed on Mar. 13, 2013.

(51) Int. Cl. C09K 8/80

(52) U.S. Cl. CPC C09K 8/80
USPC 507/221

(57) ABSTRACT

Composite mixtures are disclosed that include: (a) proppant, and (b) fibers, and/or (c) one or more of an organic binder, wax, gel, oil or polymeric binder. A method for improving the engineering properties of proppants includes adding one or more of the materials to the proppant, and mixing them for incorporation into a hydraulic fluid (such as water). Alternatively, the proppants, and/or fibers and/or other constituents may be added separately to a hydraulic fluid such as water.

### CROSS REFERENCE TO RELATED APPLICATIONS

This Application claims priority to U.S. Provisional Application No. 61/780,633 filed on Mar. 13, 2013, the disclosure of which is incorporated by reference. U.S. Publication No. 2009/0317195 A1 is also incorporated herein by reference.

### FIELD OF THE INVENTION

The present invention improves the strength of the combined, supportive materials used to maintain fissures opened in rock formations when utilizing hydraulic fracturing, and can also concentrate more supportive material in the fissures, thereby rendering extraction fissures more durable and efficient.

### BACKGROUND OF THE INVENTION

Polypropylene fiber has in the past been used to increase the shear strength of soil wherein the fibers are incorporated into the soil by mixing to achieve relatively uniform distribution of fibers in the soil. Shear strength increases have been observed depending on the fiber addition rate, fiber length, and fiber type. In general, as the fiber addition rate increased, one benefit of fiber reinforcement is increased friction angle. Fiber-reinforced soil has been used in numerous applications, but has generally been restricted to ground surfaces. Most of the soils utilizing fiber reinforcement have had been cohesive (clay) soils used to repair shallow slope failures or to improve pavement subgrades.

Hydraulic fracturing (“called “fracking”) is a known process used primarily to recover oil and natural gas from shale, sandstone or other underground rock formations. The rock is fractured using water or another fluid propelled at an extremely high pressure. Incorporated with the fluid is typically a proppant, which props open the newly created fissure so that the weight of the surrounding rock formations does not cause the fissure(s) to close.

The hydraulic fracturing fluid is typically 98% water with proppant, which is either sand and/or small man-made ceramic spheres. Preferably, 55-60 lbs. of proppant is added per cubic foot of water. The water also includes about 2% chemical additives, such as oxiders, enzymes, and gels, which meet specific requirements as viscosity enhancers, and/or friction reducers during the fracking process and thereafter.

The fluid/proppant mixture is pumped into the shale or other rock structures inside the earth at high pressures to create fractures or fissures, through which trapped oil and gas is released.

These fractures, or fissures, are propped open by the proppant, which facilitates the flow of gas and/or oil therethrough, and the gas and/or oil is then collected. Proppant efficiency, which means the ability of the proppant to hold open fissures, varies with the quality of the proppant used and the amount of proppant congregated within a fissure. Manufactured ceramic spheres are generally more uniform and more crush resistant than sand.

Polypropylene fibers have been used to increase the shear strength of soil when the fibers are incorporated into the soil. Mixing the fibers, along with moisture-conditioning, was utilized to produce a soil that could be used as structural fill when placed and compacted. Shear strength of the sand increased depending on the amount of fiber added, fiber length, and fiber type. In general, as the amount of fibers per weight in a soil mixture increased, fiber-reinforcement was found in increased friction angle.

As used herein, the terms in quotations below are defined as follows:

a. The term “sand” refers to any granular material formed by the disintegration of rocks to form particles smaller than gravel but coarser than silt. Sand may or may not include organic matter, and includes granular material farmed partially or entirely of quartz.

b. The term “silt” refers to any unconsolidated sedimentary material with rock particles usually 1/20 millimeter or less in diameter, and being generally smaller than sand but coarser than clay. Silt may or may not include organic matter.

c. The term “clay” refers to any (1) inorganic earth surface material that is plastic when moist but hard when fired and that is comprised primarily of hydrous aluminum silicates and/or other minerals, or (2) substance having the properties of clay. Clay includes dry or wet materials and may or may not include organic matter.

d. The term “organic binder” refers to any material, which can be a carrier of defined below, that consists primarily of organic matter and that tends to bind proppant particles together when mixed with proppant and wetted. Organic binders include dried and ground plantago and guar.

e. The term “carrier” refers to any material that is granular (or particulate) at room temperature and that, when mixed with one or more of a particular oil, polymeric binder, gel and/or wax forms a soil conditioning product that may be mixed with proppant and/or water for hydraulic fracking as a granular material rather than as a liquid. Preferred carriers are organic binders such as dried and ground plantago and guar.

f. The term “fibers” or “synthetic fiber” refers to any fibers, ribbons or strips of material used to add mechanical strength.

g. The term “proppant conditioner” means any mixture of (a) carrier and one or more of: oil, polymeric binder, gel and wax, wherein the proppant conditioner is a granular material at least at temperatures between about 60° F.-90° F., and more preferably at temperatures between about 40° F.-100° F., or even a greater range, and that can bind together proppant particles, or (b) one or more of: an oil, a polymeric binder, a gel and a wax.

h. “Proppant” means one or more of sand and man-made ceramic spheres, or other hard, granular materials that can prop open fissures made during fracking.

### SUMMARY OF THE INVENTION

The addition of certain manmade fibers or other materials to hydraulic fluid (such as water) used for fracking can improve the load-bearing capacity of proppant alone, and add resistance to compression by layers of rock, which is important to keeping fissures that are created during fracking open.

It has been found that aspects of the present invention provide improvement of over 30% in engineering properties at 0.5% by weight of fibers mixed with proppant (which means the dry weight of the proppant). Thus, fiber mixed with proppant provides strength enhancements. The fibers may be bio-degradable, thereby reducing environmental impact after being used.

Aspects of the present invention provide a proppant/fiber mixture having improved resistance to settlement, thereby rendering newly-created fissures more durable and efficient. One a composite mixture according to the invention comprises proppant and about 0.1 to 5% by weight of fiber. Additionally, other materials may be mixed therein.

One preferred method and product according to the present invention includes the steps of adding from about 0.1 to 5% by weight of synthetic fiber to dry proppant and mixing it to form a blend. The mixture can then be added to a fracking fluid, such as water. Or, the proppant and fibers may be added separately to the fracking fluid.

Additionally, the invention may include one or more constituents that binds together proppant particles and/or fiber to help concentrate or congregate them within fissures. The greater the amount of load bearing proppant and/or fibers in a fissure, the greater the likelihood that the fissure will remain open. The constituents can be one or more of an organic binder, gel, polymeric binder, oils, waxes, and the like.

In summary, the invention improves the load bearing capacity and compressive strength of hydraulic fracturing proppants by the addition of fibers and/or binding constituents. This assists in the efficient flow of oil and/or natural gas through fissures created by fracking.

### DETAILED DESCRIPTION OF PREFERRED EMBODIMENTS

One preferred embodiment of the present invention is a mixture of fibers with proppant.

The fibers added to the proppant can be from a broad class of thermoplastic fibers such as olefins, nylons, polyester and acrylics. Biodegradable fibers such as rayon and acetate may also be used. Preferably, the fibers should neither affect the proppant material nor be affected by the proppant, thereby maintaining their basic structural integrity throughout their useful life.

The most preferred fibers include olefins, particularly polypropylene, but are not limited to olefins. Thermoplastic fibers having specific gravities ranging from about 0.80 to 1.96 are typically suitable, although the invention is not limited to this range.

The configuration of the fibers is most preferably a 50/50 blend of monofilaments and fibrillated film fibers, although any suitable fiber(s) may be used.

Fiber cross-sectional configurations such as rectangular, square, round, oval (with any being solid or hollow) and the like may be used. Preferably the fibers are substantially uniformly dispersed in the proppant. As used herein “uniformly dispersed” means “substantially uniformly dispersed” since it is impractical to completely uniformly disperse the fibers in the proppant.

Configurations in the lengthwise direction of the fibers are fibrillated, collated, multifilament, monofilament and roll embossed film. These variations are known within the fiber engineering community.

Fiber length can be of any suitable amount and the range and is preferably from about 0.12 to 4.0 inches, with 0.12 to 0.75 inches being most preferred. The fiber diameter can be of any suitable amount and is preferably between about 0.010 to 0.10 inches, and can vary depending upon the application, as understood by those in the art.

Uniform and/or random length and/or diameter fiber blends may be used, as well as any suitable uniform or mixture of fiber cross-section(s).

The amount of fiber added to the proppant preferably ranges from about 0.1 percent to 5.0 percent by weight with 0.10 to 2.0 percent being most preferred.

The fibers may be added to the proppant at any suitable location, including at the site, or off-site at a blending station, or even mixed into water or other fluid that already contains the proppant, or the proppant and fibers can be mixed simultaneously with the fluid. The proppant and fibers may be mixed using rotary blending equipment such as pug mills or mobile concrete trucks. The blended fiber and proppant can be transported in boxes or bulk thereafter. Neither the composite mixture nor the method of the present invention is to be limited by any technique of mixing.

### Organic Binder or Carrier

The invention may include a carrier (as used herein “a” carrier means one or more carriers). The carrier is preferably one or more organic binders, such as dried and ground plantago. If dried and ground plantago is used, it preferably includes plantago seed husk and preferably includes 80% or more plantago seed husk, and most preferably includes 90% or more seed husk. Other binders, either organic (such as powdered guar gum) or inorganic, may be utilized alone or in combination. In the preferred embodiment, if used as a carrier, the carrier or organic binder is one that absorbs or adsorbs part of an oil, gel, polymeric binder and/or wax so that the resulting proppant conditioner can be added to proppant as a granular material at temperatures of at least between about 60° F. and 90° F. and most preferably at even a wider range of temperatures.

The amount and type of carrier or organic binder included is chosen to provide the desired properties of the proppant conditioner mixture. Preferably a carrier comprises between 20 and 80% by weight carrier and the remainder is one or more of oil, gel, polymeric binder or wax. Other weight percentages, however, may be utilized depending upon the nature of the carrier and the type(s) of oil, polymeric binder, gel and/or wax added, the type of proppant to which the proppant conditioner is to be added, and the desired properties of the conditioned proppant.

### Oil

The term “oil” means any substance, such as a non or low aromatic oil, paraffinic oil, soy bean oil, cotton seed oil, other vegetable oil, petroleum oil, or mineral oil, into which a polymeric binder can be dispersed or dissolved. “Oil” could also be an aqueous solution, depending upon the nature of the carrier (if utilized) and other constituents (if utilized), although a non-aqueous solution is preferred. As used herein, “an” oil refers to one or more oils. An oil may alone, or in combination with one or more other constituents, be added to soil or a carrier in any suitable form, such as a liquid (with or without heating) or as one or more emulsions. In one aspect of the present invention the purpose of the oil is to provide a medium in which to dissolve or disperse the polymeric binder, gel and/or wax and create a formulation that may be mixed with the carrier to form a substance that can be added to soil as a granular material.

Among the suitable petroleum oils are those containing low or no aromatic fractions, and that are generally fluid at temperatures between 30° F. and 120° F. Examples of oils suitable for use in the present invention include paraffinic oils and low-aromatic naphthenic oils. A commercially available example of a paraffinic oil includes Exxon's 150 SE solvent extracted bright stock FN-2507, and of a low-aromatic naphthenic oil includes Cyclolube No. 2290 available from Witco. Additionally, soy oil, cotton seed oil, other vegetable oils, or mineral oil may be used. The most preferred oil is soy oil. An example of a commercially available soy oil is Archer Soybean Oil, product no. 86-070-0 available from Archer Daniels Midland Company, Oils and Fats Division, 4666 Faries Parkway, Ill. HT-100 mineral oil from IGI is most preferred among mineral oils.

### Polymeric Binder

A polymeric binder according to the invention is any substance that may be dissolved or dispersed in an oil, that is tackier than and has a higher viscosity than the oil, and that provides adhesion between proppant particles. As used herein, “a” polymeric binder means one or more polymeric binders. The polymeric binder helps to bind proppant particles, because of the particle adhesion it provides, and because it preferably is water resistant. A polymeric binder may alone, or in combination with one or more other constituents, be added to a proppant or fluid/proppant mixture, or to a carrier in any suitable form, such as a liquid (with or without heating, depending on the properties of the polymeric binder) or as one or more emulsions.

Polymeric binders suitable for use in the present invention include interpolymers of butene, ethylene and/or propylene with ethylenically unsaturated monomers, including vinyl acetate, methyl acrylate, ethyl acrylate and the like. Other polymeric binders suitable for use in the present invention include amorphous polymers that are soluble or dispersible in an oil according to the invention. Commercially available examples of suitable polymeric binders include VESTOPLAST 608 or 708. The most preferred polymeric binder is VESTOPLAST S1, and is supplied by CREANOVA Inc., Turner Place, Box 365, Piscataway, N.J. 08855.

### Gel

The term “gel” means a gelatinous material, such as petroleum jelly. A gel according to the invention can be used in place of oil, or in addition to the oil, or in place of the polymeric binder, or in place of oil and polymeric binder, or alone, or just as another constituent along with other constituents, depending upon the viscosity of the gel, its ability to bind proppant particles, the type of proppant utilized, and the other constituents utilized. As used herein “a” gel means one or more gels. A gel may alone, or in combination with one or more other constituents, be added to a proppant or a carrier in any suitable form, such as a liquid (with or without heating, depending on the properties of the gel) or as one or more emulsions.

A preferred gel is PETOX 310, which has the consistency of soft petroleum jelly.

### Wax

A mixture of the present invention may include a wax with a proppant. The term “wax” means any substance, such as soy wax, other vegetable waxes, microcrystalline-based slack wax, or paraffin wax, that has water repellency properties and softens when heated to between 80° F. and 400° F., and most preferably between 80° F. and 200° F., so that it can be mixed with (1) a soil, (2) one or more of an oil, gel and/or polymeric binder to be further mixed with soil or a carrier, or (3) a carrier. As used herein “a” wax means one or more waxes and a wax used in the invention may or may not be microcrystalline. A wax may alone, or in combination with one or more other constituents, be added to a proppant or a carrier in any suitable form, such as a liquid (with or without heating, depending on the properties of the wax) or as one or more emulsions, powders or pelletized waxes.

The purpose of the wax is to help find the proppant and form a consistent, wax firm with proppant particles that provides cohesiveness between the proppant particles. Any wax capable of performing these functions may be used. The wax may be preferably heated to be mixed with the carrier, a proppant or one or more of an oil, gel, and polymeric binder (after which the mixture is mixed with a carrier or directly with proppant). The wax may alternatively be added to any of the above as powder, pellets or an emulsified wax.

Among the waxes that may be used to practice the invention is IGI 422. IGI 422 is a microcrystalline-based slack wax. It is recommended for use as a coating or for impregnating for waterproofing, sweeping compounds, metal protection, lubricating, polishing, tanning, and has the following physical properties:

| | ASTM | SPECIFICATIONS | | |
|---|---|---|---|---|
| TEST METHODS | METHOD | Minimum | Maximum | TYPICAL |
| Drop Melt Point ° F. | D 127 | — | — | 166 (74.4) |
| (° C.) | | | | |
| Congealing Point ° F. | D 938 | 153 (67.2) | 167 (75) | 160 (71.1) |
| (° C.) | | | | |
| Kinematic Viscosity, | D 445 | 16.0 | 23.0 | 19.5 |
| cSt @ 210° F. (98.9° C.) | | | | |
| Saybolt Viscosity, | D 2161 | 81.9 | 111.4 | 96.4 |
| SUS @ 210° F. | | | | |
| (98.9° C.) | | | | |
| Solvent Extractables*, | D 3235* | — | — | 20.0 |
| Wt % | | | | |
| Flash Point (P.M.), ° F. | D 93 | 464 (240) | — | 504 (262) |
| (° C.) | | | | |
| Color | D 1500 | — | — | 3.0 |

*Modified test method. 1 g sample/30 mls solvent (60% MEK, 40% Toluene)

FDA STATUS: IGI 422 is not intended for food contact.

IGI 1266U is another wax that may be used to practice the invention. IGI 1266U is a relatively high melting, refined paraffin wax and may be used for applications which do not require a wax meeting FDA specifications. IGI 1266U has the following physical properties:

### Physical Properties

| | ASTM | SPECIFICATIONS | | |
|---|---|---|---|---|
| TEST METHODS | METHOD | Minimum | Maximum | TYPICAL |
| Congealing Point ° F. | D 938 | 154 (67.8) | 160 (71.1) | 157 (69.4) |
| (° C.) | | | | |
| Kinematic Viscosity, | D 445 | 6.7 | 7.8 | 7.3 |
| cSt @ 210° F. (98.9° C.) | | | | |
| Saybolt Viscosity, | D 2161 | 48.1 | 51.8 | 50.1 |
| SUS @ 210° F. | | | | |
| (98.9° C.) | | | | |
| Oil Content, Wt % | D 721 | — | 1.0 | — |
| Color | D 1500 | — | — | L1.0 |
| | | | | (Off- |
| | | | | white/tan) |
| Odor | D 1833 | — | — | 2 |
| Needle Penetration, | D 1321 | — | — | 12 |
| dmm @ 77° F. (25° C.) | | | | |

FDA STATUS: IGI 1266U is not intended for food contact.

Each of the above-described waxes are sold by The International Group, Inc. (“IGI”), with locations at: 85 Old Eagle School Road, P.O. Box 384, Wayne, Pa. 19087 and 50 Salome Drive, Agincourt, Ontario, Canada M2S 2A8.

One preferred wax is a soy wax. Among the soy waxes that may be used to practice the present invention are hydrogenated soybean oil product numbers 86-193-0 and 88-583-0 sold by Archer, Daniels Midland Company, Oils and Fats Division, 4666 Faries Parkway, Decatur, Ill. In alternate embodiments, the soy wax may be a partially hydrogenated soybean oil.

Any of the above substances, i.e., a carrier including one or more constituents, an organic binder alone, an oil, a gel, a wax and/or a polymeric binder, may be added to (1) proppant, (2) a proppant/fiber mixture, or (3) a fluid containing proppant and/or fibers. Further, proppant and/or fiber may first be added to one or more of the above substances. The method and manner of mixing the various components is not relevant to a mixture according to the invention unless specifically set forth in a claim.

### EXAMPLE 1

The following example was undertaken to test the effect of fiber reinforcement on the internal friction angle of sand.

Sand

The sand was uniform, well-rounded proppant-quality sand in the size range of No. 20 to No. 40 U.S. Sieve sizes, and is referred to as “20/40 sand” or simply “sand.” The 20/40 sand was processed in general accordance with ASTM C702-98.

Fiber

The following polypropylene fibers were used: ½-inch fibrillated, 1500 denier; ¼-inch fibrillated, 1500 denier; ¼-inch fibrillated, 600 denier; ½-inch monofilament, 15 denier; ½-inch monofilament, 6 denier; and ¼-inch monofilament, 6 denier.

At ½-inch length, the fibrillation of the 1500 denier fiber was evident by manual opening of the fiber. The fibrillation of the 600 denier fiber was largely eliminated by the 6-inch length, so it probably performed as a non-fibrillated tape.

Mixability

Mixtures of 20/40 sand and fibers were tested for mixability at fiber addition rates of 0.25 percent by weight of fiber to the weight of sand, and 0.5 percent by weight of fiber to the weight of sand. The six fiber mixtures used to create twelve sand-fiber mixtures (one each of 0.25 percent by weight of fiber and 0.5 percent of weight by fiber) were: (1) ½-inch fibrillated, 1500 denier and ¼-inch fibrillated, 600 denier; (2) ¼-inch fibrillated, 1500 denier and ½-inch monofilament, 15 denier; (3) ½-inch fibrillated, 1500 denier and ½-inch monofilament, 15 denier; (4) ½-inch monofilament, 15 denier and ¼-inch fibrillated, 6 denier; (5) ½-inch fibrillated, 1500 denier and ¼-inch fibrillated, 1500 denier; and (6) ½-inch monofilament, 6-inch denier and ¼-inch fibrillated, 600 denier.

Each sample consisted of about 10 pounds of sand at a moisture content of 6 percent by weight and fiber at the weight addition rates above (for a total of twelve samples). Each sample was mixed in a Lancaster mixer for 30 seconds. All of the mixtures blended without difficulty.

Pumpability

A concrete pump was employed to test the pumpability of the mixtures. The pump had a piston diameter of about 3 inches, which exited to a 1-inch diameter orifice feeding a 1-inch diameter hose. The flange connecting the 3-inch cylinder to the 1-inch orifice provided no transition from the larger to the smaller diameter, increasing the potential for blockage at the orifice with stiffer mixtures. Initially, pumping of a mixture of 20/40 sand and water was attempted, with almost immediate blockage. The mix water was treated with PDSCo Super Mud®, which is a polymer drilling fluid. 60 milliliters (ml) was added to each 4 gallons of water. The mixture then pumped with no blockage in either the pump or the 1-inch diameter hose.

Mixtures of 20/40 sand and fiber were then tested using mix water treated with the polymer drilling fluid at 60 ml per 4 gallons of water. The results are summarized in Table 1:

TABLE 1
Fiber Sand Mixtures

| | Fiber Mixture (50/50) | | | |
|---|---|---|---|---|
| | ½″ fibrillated 1500 d + | ½″ fibrillated 1500 d + | ½″ fibrillated 1500 d + | ½″ fibrillated 1500 d + |
| | ¼″ mono 6 d | ¼″ mono 6 d | ½″ mono 15 d | ¼″ fibrillated 600 d |
| Percent fiber by | 1.0% | 0.5% | 0.5% | 0.5% |
| weight | | | | |
| Pumping result | blocked | pumped | blocked | Blocked |
| Slump | 9½″ | 10¼″ | 8½″ | 10½″ |

Blockage occurred in the pump, where the 3-inch diameter cylinder met the flange with the 1-inch diameter orifice. In all cases, the 1-inch diameter hose was not blocked, even when filled with the fiber-sand mixture. This suggests that pumping equipment modified with a smooth-walled reducer between the cylinder and the orifice could be utilized to pump any of the twelve mixtures listed above.

Flowability

While slump tests were being performed on the fiber-sand mixtures, the spread of the slump test was measured and found to be between 26 and 27 inches. For comparison, self-consolidating concrete intended to provide good flowability around reinforcing steel has a typical spread of about 26 inches.

Internal Friction

20/40 sand and a fiber-sand mixture were each tested for shear strength using triaxial equipment. The fiber was a 50/50 blend of ½-inch fibrillated 1500 denier and ¼-inch monofilament 6 denier mixed at a rate of 0.5 percent by weight with 20/40 sand. Ordinarily, laboratory soil samples were remolded using compaction or vibration to achieve a target density. For this testing, the 20/40 sand and fiber-sand mixtures were suspended in polymer drilling fluid at the same concentration referenced above. The respective samples were introduced into a plastic cylinder with an internal diameter of 2.85-inches with top and bottom drainage, and allowed to settle beneath a static weight of 30 pounds, equivalent to 4.7 pounds per square inch (psi), for a period of 24 hours. The results are summarized in Table 2:

TABLE 2
Consolidation Data for Remolded Samples

| | 20/40 | 20/40 Sand with | |
|---|---|---|---|
| Pre-test sample data | Sand | 0.5 percent fiber | Difference |
| Initial moisture content (%) | 23.2 | 26.5 | +3.3 |
| Moisture content after settling | 19.4 | 22.3 | +2.9 |
| beneath 30-pound load (%) | | | |
| Moisture loss during settling (%) | 3.8 | 4.0 | — |
| Loss in height during settling (%) | 11.9 | 19.7 | +7.8 |

Note that the polypropylene used was hydrophobic, so the fiber did not absorb water. Since the respective samples were mixed with equal rates of polymer drilling fluid, the higher moisture content of the fiber-sand mixture is indicative of the more “open” structure created by addition of fibers. The samples were then extruded, encapsulated in rubber membranes, and subjected to triaxial shear testing using the consolidated drained (CD) procedure. Specimens of each mixture were subjected to confining pressures of 5 psi, 10 psi, and 20 psi, and were then loaded in compression to failure. The testing of the sand indicated an internal friction angle of 16.3 degrees at an apparent cohesion of 3.3 psi. With the addition of fibers, the apparent cohesion was much lower, i.e., 0.6 psi with an internal friction angle of 27.5 degrees. When the data for the confining pressure of 20 psi was used to determine the internal friction angle without cohesion, the results are as shown in Table 3:

TABLE 3
Shear Strength of 20/40 Sand and Fiber Sand Mixture

| Material | Internal Friction Angle |
|---|---|
| 20/40 Sand | 20.2 degrees |
| 20/40 Sand with 0.5 percent fiber by weight | 26.4 degrees |

The addition of fibers at the specified addition rate increased the internal friction angle by over 30 percent. This increase is more than twice of that predicted by available models for estimating shear strength increase for fiber addition. Note that existing models were developed and verified experimentally for fibers typically in the range of 1½ to 2 inches long. These test results demonstrate that synthetic fibers added to 20/40 sand provide significant increased shear strength (internal friction), as well as enhanced flowability and pumpability when used in conjunction with water modified with polymer drilling fluid.

Any of the twelve sand-fiber mixtures of Example 2 could also include one or more of an organic binder, a wax, oil, gel or polymer to increase adhesion, as set forth herein.

Some non-limiting examples of embodiments of the invention follow:

### Example 1

A reinforced hydraulic fracturing mixture to be added to a fluid, the mixture comprising: proppant and from 0.1 to about 5.0 percent by weight of fibers mixed substantially, uniformly throughout the proppant.

### Example 2

The mixture of example 1 wherein the proppant is sand.

### Example 3

The mixture of example 1 wherein the proppant is ceramic spheres.

### Example 4

The mixture of example 1 wherein the proppant is a mixture of sand and ceramic spheres.

### Example 5

The mixture of any of examples 1-4 wherein the fibers are between 0.1 and 2.0 percent by weight of the mixture.

### Example 6

The mixture of any of examples 1-5 wherein the fibers are comprised of thermoplastic polymers.

### Example 7

The mixture of example 6 wherein the specific gravity of the thermoplastic ranges from about 0.80 to 1.96.

### Example 8

The mixture of any of examples 1-7 wherein the fibers are biodegradable.

### Example 9

The mixture of example 8 wherein the fibers are comprised of one or more of the group consisting of: rayon, acetate and biodegradable polyolefins.

### Example 10

The mixture of any of examples 1-9 wherein the fibers are from about 0.12 to 4.0 inches in length.

### Example 11

The mixture of any of examples 1-10 wherein the fibers have a uniform length.

### Example 12

The mixture of any of examples 1-10 wherein the fibers vary in length.

### Example 13

The mixture of any of examples 1-12 wherein the fibers are flat.

### Example 14

The mixture of example 13 wherein the fibers have a thickness of between 0.010 to 0.10 inches.

### Example 15

The mixture of any of examples 1-12 wherein the fibers have a cross section other than flat.

### Example 16

The mixture of example 15 wherein the fibers have a maximum thickness of between 0.010 and 0.10 inches.

### Example 17

The mixture of any of examples 1-12 which includes flat fibers and fibers having a cross section other than flat.

### Example 18

The mixture of example 17 wherein the maximum thickness of the fibers is between 0.010 and 0.10 inches.

### Example 19

The mixture of any of examples 15-18 wherein at least some of the fibers have a cross-sectional area selected from the group consisting of: rectangular, square, round, and oval.

### Example 20

The mixture of example 19 wherein at least some of the fibers are hollow.

### Example 21

The mixture of any of examples 1-20 wherein the fibers are polypropylene.

### Example 22

The mixture of any of examples 1-21 wherein the fibers are biodegradeable.

### Example 23

The mixture of any of examples 1-22 wherein the length of the fibers is between 0.12 to 0.75 inches.

### Example 24

The mixture of any of examples 1-2 and 5-23 wherein the proppant is sand in the size range of No. 20 to No. 40 U.S. sieve.

### Example 25

The mixture of any of examples 1-24 wherein the fibers are a blend of ½″ fibrillated 1500 denier and ¼″ monofilament 6 denier.

### Example 26

The mixture of any of examples 1-25 that further includes 0.2 to 10% by weight of an organic binder.

### Example 27

The mixture of example 26 that includes 1 to 2% by weight of organic binder.

### Example 28

The mixture of either of examples 26 or 27 wherein the organic binder comprises dried and ground plantago.

### Example 29

The mixture of either of examples 26 or 27 wherein the organic binder comprises ground and dried plantago seed husk.

### Example 30

The mixture of example 29 wherein the organic binder includes at least 85% dried and ground plantago seed husk.

### Example 31

A hydraulic composition including fluid and the mixture of any of examples 1-30.

### Example 32

The hydraulic composition of example 31 wherein the fluid is water.

### Example 33

A mixture of proppant, 0.1 to 5.0 percent by weight of fibers, and with between 1-20% by weight of (a) a carrier, and (b) one or more of an oil, a gel, a polymeric binder and a wax.

### Example 34

The mixture of example 33 wherein the carrier includes organic binder.

### Example 35

The mixture of example 34 wherein the carrier includes dried and ground plantago.

### Example 36

The mixture of example 35 wherein the carrier includes dried and ground plantago seed husk and guar.

### Example 37

The mixture of example 36 wherein the carrier comprises 80% or more dried and ground plantago seed husk.

### Example 38

The mixture of example 33 that comprises wax.

### Example 39

The mixture of example 38 wherein the wax is soy wax.

### Example 40

The mixture of example 39 wherein the wax is an emulsified wax.

### Example 41

The mixture of example 39 wherein the wax is a hydrogenated soy wax.

### Example 42

The mixture of example 33 that comprises an oil.

### Example 43

The mixture of example 42 wherein the oil is soy oil.

### Example 44

The mixture of example 42 wherein the oil is mineral oil.

### Example 45

The mixture of example 42 wherein the oil is petroleum oil.

### Example 46

The mixture of example 42 wherein the oil is paraffinic oil.

### Example 47

The mixture of example 42 wherein the oil is low-aromatic, vapthenic oil.

### Example 48

The mixture of example 42 wherein the oil is cotton seed oil.

### Example 49

The mixture of example 42 wherein the oil is IGI HT-100 oil.

### Example 50

The reinforced hydraulic fracturing mixture of example 1 that comprises a polymeric binder.

### Example 51

The mixture of example 50 wherein the polymeric binder comprises amorphous olefin.

### Example 52

The mixture of example 50 wherein the polymeric binder is Vestoplast 608.

### Example 53

The mixture of example 50 wherein the polymeric binder is Vestoplast 708.

### Example 54

The mixture of example 1 that comprises wax and oil wherein the percentage by weight of wax to oil is between 10% to 90%.

### Example 55

The mixture of example 1 that comprises wax and oil wherein the percentage by weight of wax to oil is between 1% and 10%.

### Example 56

The mixture of example 55 that further comprises a gel.

### Example 57

The mixture of example 56 wherein the gel comprises PETOX 310.

### Example 58

The mixture of example 31 wherein the carrier and one or more of an oil, a gel, a polymeric binder and a wax are mixed together in a pug mill.

### Example 59

The mixture of example 33 wherein the one or more of an oil, a gel, a polymeric binder and a wax are heated and mixed with the carrier.

### Example 60

The mixture of example 33 or 34 wherein the polymeric binder is dispersed in the oil to create a formulation that is mixed with the carrier.

### Example 61

The mixture of example 33 that includes 20-80% by weight of carrier per the weight of one or more of the oil, gel, polymeric binder and wax.

### Example 62

The mixture of any of examples 33-61 that include 80%-90% by weight of proppant.

### Example 63

The mixture of any of examples 33-62 that further includes fibers.

### Example 64

The mixture of example 63 that includes 0.1% to 2% by weight of fibers.

### Example 65

The mixture of any of examples 1-5 wherein the fibers are comprised of thermoplastic polymers.

### Example 66

The mixture of example 6 wherein the specific gravity of the thermoplastic ranges from about 0.80 to 1.96.

### Example 67

The mixture of any of examples 1-7 wherein the fibers are biodegradable.

### Example 68

The mixture of example 8 wherein the fibers are comprised of one or more of the group consisting of: rayon, acetate and biodegradable polyolefins.

### Example 69

The mixture of any of examples 33-68 wherein the fibers are from about 0.12 to 4.0 inches in length.

### Example 70

The mixture of any of examples 33-69 wherein the fibers have a uniform length.

### Example 71

The mixture of any of examples 33-69 wherein the fibers vary in length.

### Example 72

The mixture of any of examples 33-71 wherein the fibers are flat.

### Example 73

The mixture of example 72 wherein the fibers have a thickness of between 0.010 to 0.10 inches.

### Example 74

The mixture of any of examples 33-71 wherein the fibers have a cross section other than flat.

### Example 75

The mixture of example 74 wherein the fibers have a maximum thickness of between 0.010 and 0.10 inches.

### Example 76

The mixture of any of examples 33-71 which includes flat fibers and fibers having a cross section other than flat.

### Example 77

The mixture of example 76 wherein the maximum thickness of the fibers is between 0.010 and 0.10 inches.

### Example 78

The mixture of any of examples 74-77 wherein at least some of the fibers have a cross-sectional area selected from the group consisting of: rectangular, square, round, and oval.

### Example 79

The mixture of example 78 wherein at least some of the fibers are hollow.

### Example 80

The mixture of any of examples 33-79 wherein the fibers are polypropylene.

### Example 81

The mixture of any of examples 33-79 wherein the fibers are biodegradeable.

### Example 82

The mixture of any of examples 33-68 or 70-81 wherein the length of the fibers is between 0.12 to 0.75 inches.

### Example 83

The mixture of any of examples 33-82 wherein the proppant is sand in the size range of No. 20 to No. 40 U.S. sieve.

### Example 84

The mixture of any of examples 33-71 or 83 wherein the fibers are a blend of ½″ fibrillated 1500 denier and ¼″ monofilament 6 denier.

### Example 85

A hydraulic composition including fluid and the mixture of any examples 33-84.

### Example 86

The hydraulic composition of example 85 wherein the fluid is water.

Having thus described preferred embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A reinforced hydraulic fracturing mixture to be added to a fluid, the mixture comprising:
proppant and from 0.1 to about 5.0 percent by weight of fibers mixed substantially, uniformly throughout the proppant.

2. The mixture of claim 1 wherein the proppant is sand.

3. The mixture of claim 1 wherein the proppant is ceramic spheres.

4. The mixture of claim 1 wherein the proppant is a mixture of sand and ceramic spheres.

5. The mixture of claim 1 wherein the fibers are between 0.1 and 2.0 percent by weight of the mixture.

6. The mixture of claim 1 wherein the fibers are comprised of thermoplastic polymers.

7. The mixture of claim 6 wherein the specific gravity of the thermoplastic ranges from about 0.80 to 1.96.

8. The mixture of claim 6 wherein the fibers are biodegradable.

9. The mixture of claim 6 wherein the fibers are comprised of one or more of the group consisting of: rayon, acetate and biodegradable polyolefins.

10. The mixture of claim 1 wherein the fibers are from about 0.12 to 4.0 inches in length.

11. The mixture of claim 1 wherein the fibers are flat.

12. The mixture of claim 11 wherein the fibers have a thickness of between 0.010 to 0.10 inches.

13. The mixture of claim 1 wherein at least some of the fibers are hollow.

14. The mixture of claim 1 wherein the proppant is sand in the size range of No. 20 to No. 40 U.S. sieve.

15. The mixture of claim 1 wherein the fibers are a blend of ½″ fibrillated 1500 denier and ¼″ monofilament 6 denier.

16. The mixture of claim 1 that further includes 0.2 to 10% by weight of an organic binder.

17. The mixture of claim 16 wherein the organic binder comprises dried and ground plantago.

18. A hydraulic composition including fluid and the mixture of claim 1.

19. The hydraulic composition of claim 18 wherein the fluid is water.

20. The hydraulic composition of claim 18 that further includes one or more of the group consisting of: (a) an organic binder, (b) wax, (c) gel, (d) oil, and (e) a polymeric binder.
